(19) United States
(12) Patent Application Publication
(10) Pub. No.: US 2005/0094407 A1
(43) Pub. Date: May 5, 2005

(54) Mid-sized traffic signal light chassis for modular intelligent traffic light system

(76) Inventors: Arthur D. Heald, Plano, TX (US); Michael C. Hutchison, Plano, TX (US); Michael J. Zalta, Richardson, TX (US)

Correspondence Address: Michael G. Cameron;Jackson Walker LLP, Suite 600, 2435 North Central Expressway, Richardson, TX, 75080, US

(21) Appl. No.: 10/945,767

(22) Filed: Sep. 21, 2004

Related U.S. Application Data
(60) Provisional application No. 60/517,174, filed on Nov. 4, 2003.

(51) Int. Cl. B60Q 3/04

(52) U.S. Cl. 362/362; 220/315; 340/907

(57) ABSTRACT

The present invention discloses a mid-sized traffic signal light chassis (201), comprising a top panel (203) having a circular opening (205), and a bottom panel (204) having a circular opening (206), wherein the top panel (203) and the bottom panel (204) provide for a mating assembly with a bushing that is adapted to secure the top panel (203) and the bottom panel (204).

### CROSS REFERENCE TO RELATED APPLICATIONS

The present invention claims the benefit of U.S. provisional patent application Ser. No. 60/517,174, filed on Nov. 4, 2003, the contents of which are incorporated by reference herein.

### BACKGROUND OF THE INVENTION

This device is related to solid-state traffic signals lights, and, more particularly, to a mid-sized traffic signal light chassis.

Full-size traffic signal lights are used to efficiently control traffic through intersections. Although full-size traffic signals have been used for many years, additional features that can be utilized in conjunction with these traffic signals, such as those produced by cameras, environmental sensors, communications and radar, have not been fully utilized on a smaller yet complementary platform.

What is desired, therefore, is a mid-sized traffic signal chassis that mounts on the traffic signal light “stack” that provides modular functionality for the traffic signal light system. The most typical mounting location for the reduced-dimensioned traffic signal light assembly is directly below the “GREEN” or “ARROW” traffic signal light (e.g. most lower signal).

### SUMMARY OF THE INVENTION

The present invention comprises a mid-sized traffic signal light chassis for a modular intelligent traffic light system. In an exemplary embodiment, a mid-sized traffic signal light chassis comprises a plurality of panels, including a top panel having a circular opening, and a bottom panel having a circular opening, wherein the top panel and the bottom panel provide for a mating assembly with a bushing that is adapted to secure the top panel and the bottom panel to adjoining assemblies.

A retrofitted backplate can be adapted to protrude below a traffic signal light, with the lower portion of the backplate having an enlarged dimension below the bottom signal light assembly to accommodate the additional mid-sized chassis. The backplate can be cut-away to allow the face of the signal light chassis to face forward in an unobstructed manner.

An objective of the present invention is to provide a weather-tight case that protects inner subassemblies. These subassemblies can include, but are not limited to, devices and printed circuit boards that provide diverse functions including cameras, environmental sensors, communications and radar. Additional mid-sized chassis can be concatenated provided the traffic signal light backplate is able to accommodate the additional chassis mountings, such as, for example, changing or extending the backplate.

### BRIEF DESCRIPTION OF THE DRAWINGS

FIG. 1A illustrates a first full-sized, or full-height, traffic signal chassis coupled to a second full-sized traffic signal chassis;

FIG. 1B illustrates an exploded view of a conventional mating assembly for coupling a first traffic signal chassis to a second traffic signal chassis;

FIG. 1C is an exploded view of a conventional assembly to secure a full-size traffic signal chassis to a mast connector;

FIG. 2 illustrates a mid-sized, or half-height, traffic signal chassis, in accordance with an exemplary embodiment of the present invention;

FIG. 3A illustrates a front view of a mid-sized traffic signal chassis with respect to a full 3-ball stack, in accordance with an exemplary embodiment of the present invention;

FIG. 3B illustrates a side view of a mid-sized traffic signal chassis with respect to a full 3-ball stack, in accordance with an exemplary embodiment of the present invention;

FIG. 4A illustrates a side view of three full-sized traffic signal chassis with respect to a full 3-ball stack, showing the a backplate mounting to a signal stack;

FIG. 4B is an exploded view of a corner of three full-sized traffic signal chassis with respect to a full 3-ball stack;

FIG. 5A illustrates a back view of backplate in relation to a signal stack comprised of three full-sized signal chassis;

FIG. 5B is an exploded view of a corner of three full-sized traffic signal chassis with respect to a full 3-ball stack.

### DETAILED DESCRIPTION OF THE INVENTION

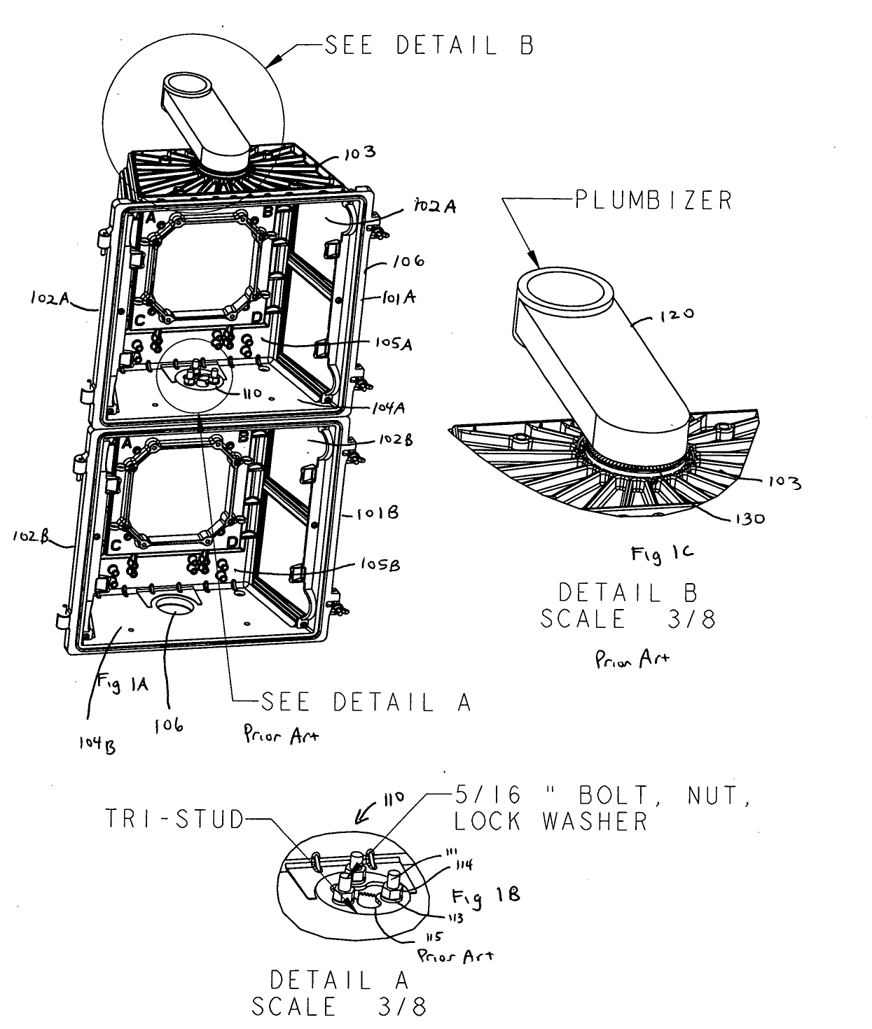

The use of letters in connection with reference numerals, such as 101A, 101B, etc. are meant to convey multiple, substantially identical devices, components or elements. A reference to the numeral without the letter, such as 101, is meant to refer to all or any one such substantially identical devices, components or elements. Referring now to FIG. 1A, a first full-sized, or full-height, traffic signal chassis 101A is shown coupled to a second full-sized traffic signal chassis 101B. The full-size traffic signal light chassis 101 has a front face 106 defined by a plane where one edge of side panels 102, top panel 103 and bottom panel 104 meet. Exemplary dimensions of the full-sized traffic signal chassis are 14.2″ W×13.4″ H×5.9″ D. The sides 102 of full-sized traffic signal light chassis 101 can have beveled inner-sloping sides, having for example a 15° angle, resulting in a telescoping rear panel 105 with a narrower but proportional width, such as 7.9″ W×13.4″ H, as dictated by this interior angle.

FIG. 11B illustrates an exploded view of a conventional mating assembly 110 for coupling the first full-size traffic signal chassis to the second full-size traffic signal chassis or to a mast connector. The mating assembly 110 uses a tri-stud hardware kit consisting of two large washers 115, three bolts 111, and an associated lock washer 113 and nut 114 for each bolt 111.

FIG. 1C is an exploded view of a conventional assembly used to secure a full-size traffic signal chassis to a mast connector 120. As seen therein, mast connector 120 connects to the top of a full-size traffic signal chassis 101. Mast connector 120 is a conventional assembly that secures a full traffic signal stack. The mast connector 120 is mounted to the traffic signal stack using a means similar to that seen in FIG. 1B. The mount consists of a tri-stud kit, but the bolts 111 are inserted into the threaded mast connector 120 instead of using nuts 114. A mast connector 120 can be mounted to a mid-sized traffic signal chassis 201 using the same procedure as described for a full-size traffic signal chassis 101.

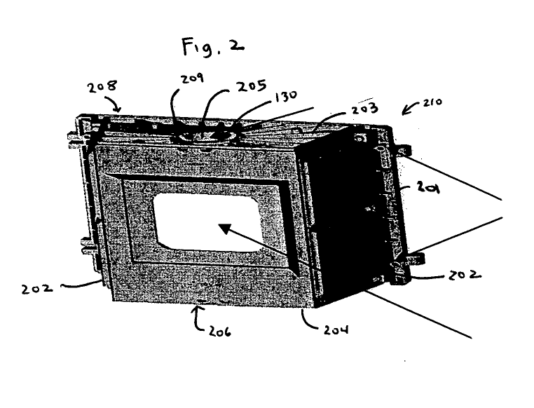

Referring now to FIG. 2, a mid-sized traffic signal light chassis 201 is depicted. The mid-sized traffic signal light chassis 201 comprises opposite facing side panels 202, a top panel 203 having a circular opening 205, and a bottom panel 204 having a circular opening 206, wherein the top panel 203 and the bottom panel 204 provide for the mating assembly (see FIGS. 1B and 1C) with a bushing that is adapted to secure the top panel 203 of a first chassis to the bottom panel of a second chassis. Front face 208 is defined by the front joined, leading edges of panels 202, top panel 203 and bottom panel 204. Top circular opening 205 and bottom circular opening 206 are located opposite each other towards the center of top panel 203 and bottom panel 204. These openings provide for a mating assembly inclusive with a bushing that secures the top and bottom of the chassis to another traffic signal light chassis or to a mast connector. With respect to the mid-sized traffic signal light chassis 201, the height dimensions disclosed with respect to a full-size traffic signal chassis are “reduced” proportionately between the top panel 203 and the bottom panel 204 from the full-sized traffic signal light chassis 101. Side panels 202, along with top panel 203 and bottom panel 204, serve to define an interior portion of mid-sized traffic signal light chassis 201. Front face portion 210 is provided around the outer perimeter of that defines the meeting of the one edge of each of the side panels 202, top panel 203 and bottom panel 204.

The mast connector 120 (as seen in FIG. 1C), assists in the coupling of the signal stack to the mast-arm of a traffic light. The upper flange 209 of mid-sized traffic signal light chassis 201 mates precisely to an adjacent traffic signal light chassis. Serrated edges 130 are included on the top and bottom portions of the flange and serve to interlock two chassis such that they are prevented from swiveling except as a single array or a stack. Mounting bolts protruding through the top panel of the mid-sized 201 traffic light chassis can serve to secure said mid-sized traffic light chassis 201 to the GREEN traffic signal light chassis. Thus, the present invention comprises a mid-sized traffic light chassis that can be easily installed below the GREEN traffic signal light, or mounted to another mid-sized traffic signal chassis 201 or a full-sized traffic signal chassis 101 and can use the same mating assembly 110.

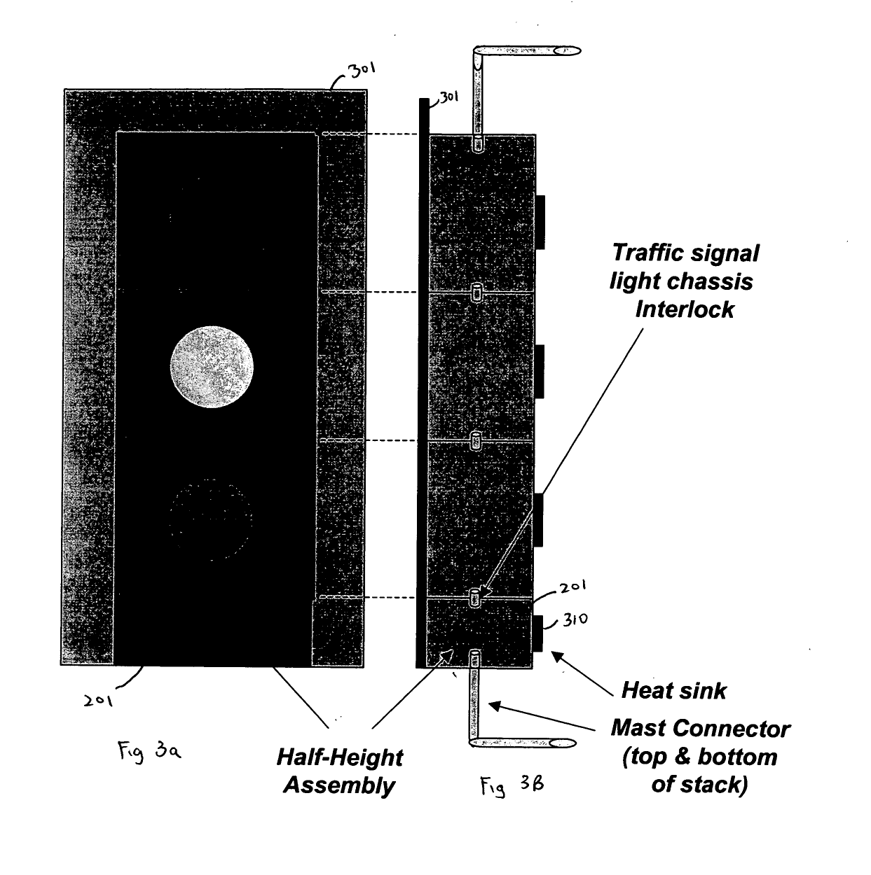

FIG. 3A illustrates a front view of a mid-sized traffic signal chassis 201 in relation to a full 3-ball stack comprising three full-sized traffic signal chassis 101. As seen therein, backplate 301 is shown mounted to the back of the front face 208 of the mid-sized traffic signal chassis 201 comprising the signal stack.

FIG. 3B is a side view of a mid-sized traffic signal chassis 201 in relation to a full 3-ball stack comprising three fill-sized traffic signal chassis 101. As seen therein, backplate 301 is shown mounted to the back of the front face of the mid-sized traffic signal chassis 201 comprising the signal stack. Heat sink 310 is seen coupled to the back of the mid-sized traffic signal chassis 201. Mid-sized traffic signal chassis 201 can be fitted with at least one heat sink to transfer heat from the inside of the chassis to the outside. The heat sink can be a standard extruded aluminum heat sink with proper coating for durability and long-life in outdoor operating conditions. A hole can be cut in the rear panel of the mid-sized traffic signal chassis so that the heat sink is in contact with heat-generating components inside the chassis.

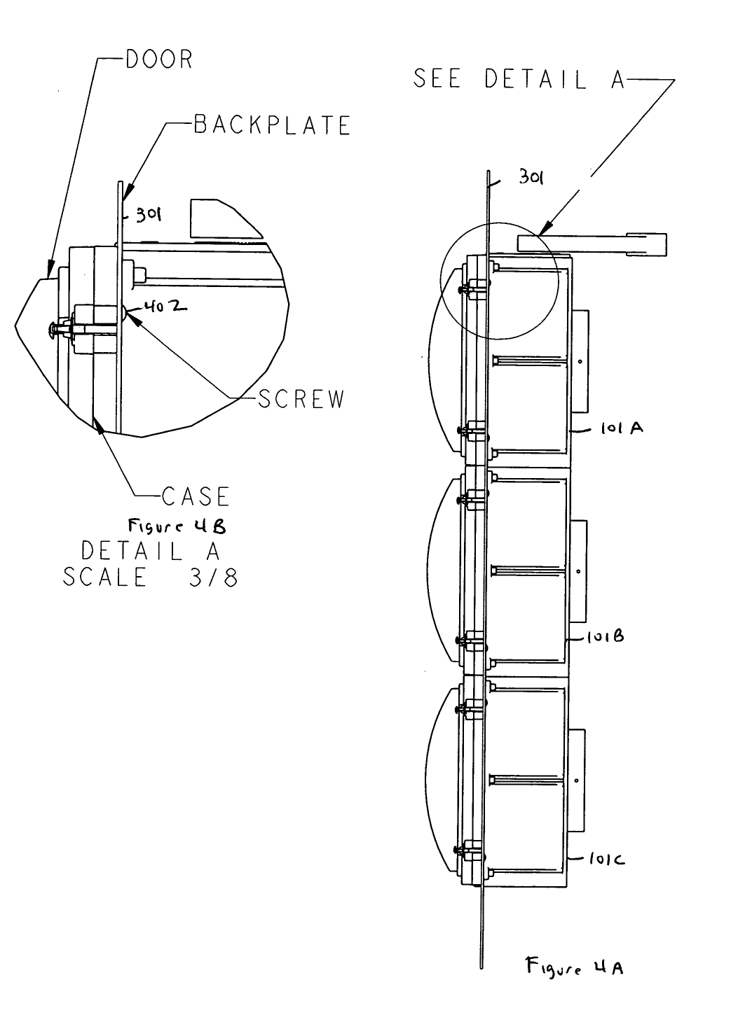

Referring to the FIG. 4A, a side view of three full-sized traffic signal chassis 101 with respect to a full 3-ball stack is shown with backplate 301 mounted to the signal stack. FIG. 4B is an exploded view of a corner of three full-sized traffic signal chassis 101 with respect to a full 3-ball stack, showing the backplate 301 in relation to a signal stack. As seen in FIG. 4B, backplate 301 is mounted to the front face of the three full-sized traffic signal chassis 101 with mounting screw 402.

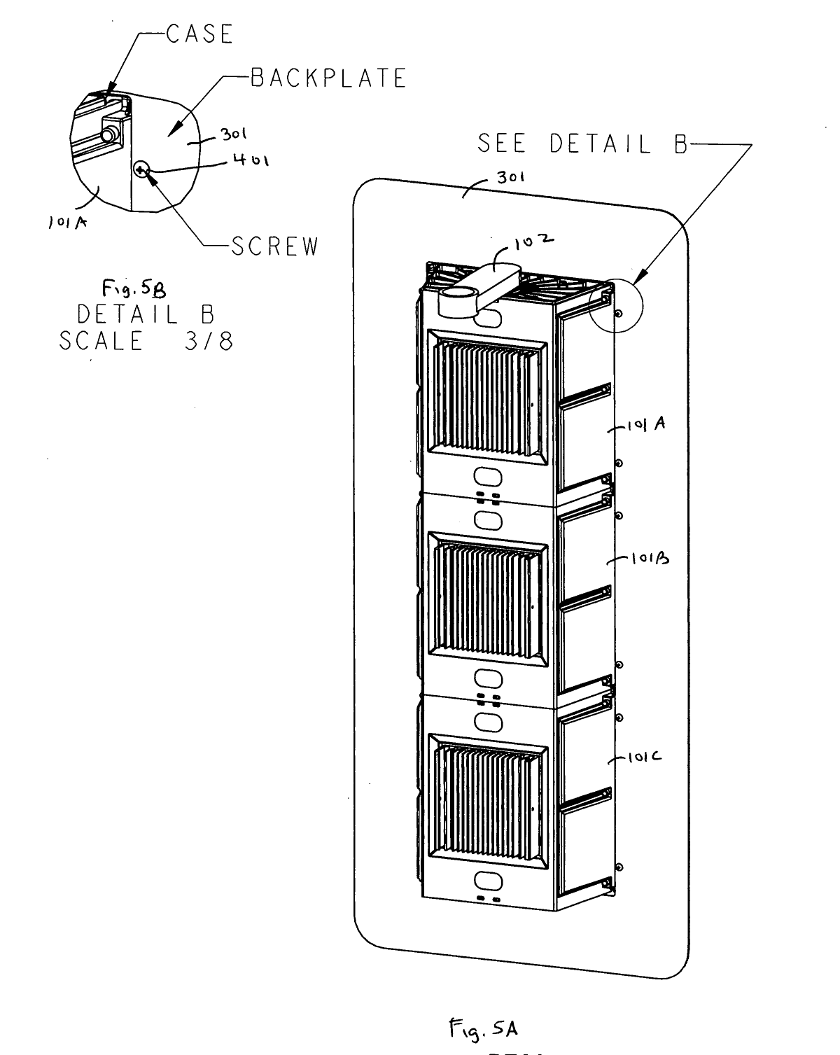

FIG. 5A provides another view of a backplate 301 in relation to a signal stack comprised of three full-size signal chassis 101. As seen in FIG. 5B, backplate 401 is mounted to the edge of front face of full-size traffic signal chassis 101 with mounting screw 402.

The front face of mid-sized traffic signal chassis 201 is adapted to couple to a backplate 301 in the same way as a full-size traffic signal chassis 101 is adapted to couple to a backplate. To accommodate the inclusion of a mid-size traffic signal chassis 201 in an existing stack comprised of three full-size traffic signal chassis 101, a lower portion of the backplate 301 is adapted to protrude with an enlarged dimension below the lowest full-sized traffic signal light chassis to accommodate at least one mount, wherein the at least one mount is adapted to couple to the backplate 301.

Backplate 301 may obscure the mid-sized chassis 201 from direct viewing, thus an optional “cut-through” of the backplate 301 may be needed for the mid-sized traffic signal light chassis 201. If the cut-through is desired, the mid-sized traffic signal assembly may require a viewable opening that permits ambient light to enter the chassis from the front, or alternatively, allows an internal light or other emissions to be directed towards the intersection. The backplate 301 may optionally be a cut-away backplate, wherein the cut-away allows a face of the mid-sized traffic signal light chassis 201 to face forward in an unobstructed manner. Further, the cut-away may be dimensioned so as to permit access to a door on the front face 208 of the mid-size traffic signal light chassis 201.

The mid-sized traffic signal light chassis 102 provides the ability to readily introduce and install various devices related to traffic signal operation in the interior portions of the mid-sized traffic signal light chassis 102 defined by its panels. These devices include, but not limited to, devices that provide sensory functions including surveillance cameras (including infrared, night-vision, et al.) and traffic radar monitoring. The devices may also include environmental weather related sensory devices (moisture, temperature, humidity, wind, barometric pressure), and also for safety and security detection of chemical/bio/nuclear emissions related to industrial manufacturing and weapons of mass destruction. Preferably, the mid-sized traffic signal light chassis 201 comprises a weather-tight case that protects inner subassemblies. The subassemblies may comprise electronics adapted to provide the foregoing functions. Multiple mid-sized traffic signal light chassis 210 are adapted to be concatenated upon one another and to support modularity with varying functions. In such a configuration, the backplate 301 may be enlarged or a new backplate used to accommodate the multiple mid-sized chassis 201. Multiple mid-sized traffic light chassis can be adapted to operate independently of one another and/or in combination with one another.

The present invention permits the addition of future functionality with only the limitation of “form and fit”. These functions may be introduced in the form of modules that are independent of one-another allowing any number of functions to coexist.

In another embodiment of the present invention, the mid-sized traffic signal light chassis 201 adapted to be coupled to a full-sized traffic signal light chassis, can have a window on the rear panel for the purpose of installing a camera to view, count or poll traffic leaving the intersection. Further, the mid-size traffic signal light chassis 201 can have a door on the rear panel for maintenance access. The mid-sized traffic signal light chassis 201 can contain subassemblies and devices comprising at least one element from a group consisting of hardware, software and firmware, wherein the at least one device is a surveillance camera, an environmental sensor, a radar, a receiver, a transmitter, a storage device, and a recording device.

Although an exemplary embodiment of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims.

1. A modular traffic signal light chassis, comprising:
a top panel, bottom panel and at least one side panel;
the top panel having a circular opening; and
a bottom panel having a circular opening, wherein the top panel and the bottom panel provide for a mating assembly with a bushing that is adapted to secure the top panel and the bottom panel.

2. The modular traffic signal light chassis of claim 1, further comprising being about one-half the height of a full-sized modular traffic signal light chassis.

3. The modular traffic signal light chassis of claim 2, further comprising:
a front face defined by the front edges of the top panel, bottom panel and at least one side panel;
wherein the front face is adapted to couple to a backplate.

4. The modular traffic signal light chassis of claim 3, further comprising:
a backplate;
wherein the backplate is adapted to couple to a mid-sized traffic signal light chassis.

5. The modular traffic signal light chassis of claim 4, wherein the backplate has a cutaway portion to permit direct viewing from the interior of the chassis.

6. The modular traffic signal light chassis of claim 4, wherein a lower portion of the backplate protrudes with an enlarged dimension below the lowest full-sized traffic signal light chassis to accommodate at least one mount.

7. The modular traffic signal light chassis of claim 6, wherein the at least one mount is adapted to couple to the backplate.

8. The modular traffic signal light chassis of claim 2 further comprising a cut-away backplate coupling the components of the traffic light chassis together.

9. The modular traffic signal light chassis of claim 8, wherein the cut-away allows the front face of the mid-sized traffic signal light chassis to face forward in an unobstructed manner.

10. The modular traffic signal light chassis of claim 8, wherein the cutaway backplate permits ambient light to enter the chassis from a front portion.

11. The modular traffic signal light chassis of claim 8, wherein the cutaway backplate permits an internal light or other emissions to be directed towards an intersection.

12. The modular traffic signal light chassis of claim 8, wherein the cut-away is optional.

13. The modular traffic signal light chassis of claim 2, wherein the chassis further comprises a weather-tight case.

14. The modular traffic signal light chassis of claim 13, wherein the chassis is adapted to house subassemblies and devices.

15. The mid-sized traffic signal chassis of claim 14, wherein such subassembly and device comprises at least one of a:
surveillance device; sensing device;
communications device;
radar device;
recording device; and
storing device.

16. The modular traffic signal light chassis of claim 2, wherein multiple mid-sized traffic signal light chassis are adapted to be concatenated upon one another.

17. The modular traffic signal light chassis of claim 16, wherein multiple mid-sized chassis support modularity with varying functions.

18. The modular traffic signal light chassis of claim 16, wherein the backplate is enlarged to accommodate multiple mid-sized chassis.

19. The modular traffic signal light chassis of claim 16, wherein an integrated backplate is used to accommodate multiple mid-sized chassis.

20. The modular traffic signal light chassis of claim 16, wherein multiple mid-sized chassis are adapted to operate independently of one another.

21. The modular traffic signal light chassis of claim 16, wherein the multiple mid-sized chassis are adapted to operate in combination with one another.

22. A mid-sized traffic signal light chassis, comprising:
a top panel;
a bottom panel;
a front face panel coupled to the top panel and to the bottom panel;
wherein the mid-sized traffic signal light chassis is adapted to be coupled to a full-sized traffic signal light chassis.

23. The mid-sized traffic signal light chassis of claim 22, comprising subassemblies and devices comprising at least one element from a group consisting of:
hardware;
software; and
firmware.

24. The mid-sized traffic signal light chassis of claim 23, wherein the at least one device is:
a surveillance camera;
an environmental sensor;
a radar;
a receiver;
a transmitter;
a storage device; and
a recording device.

25. The mid-sized traffic signal light chassis of claim 22, further comprising a first side panel and a second side panel, wherein the side panels are coupled to the top panel, the bottom panel and the front face panel.

26. The mid-sized traffic signal light chassis of claim 25, further comprising a rear panel coupled to the side panels, the top panel, and the bottom panel.

27. The mid-sized traffic signal light chassis of claim 26, further comprising mounts coupled to the back of the front face panel.

28. The mid-sized traffic signal light chassis of claim 27, wherein the backplate is adapted to couple to the mid-sized traffic signal light chassis.
